(19) United States
(12) Patent Application Publication
(10) Pub. No.: US 2017/0314715 A1
(43) Pub. Date: Nov. 2, 2017

(54) DISSIMILAR PIPING JOINT AT HIGH TEMPERATURE, HIGH PRESSURE TRANSIENT AND UNDER CYCLIC LOADING

(71) Applicant: General Electric Technology GmbH, Baden (CH)

(72) Inventors: Guenter SCHMALZBAUER, Rheinfelden (DE); Lars SACHS, Wuerenlos (CH); Daniel PONCA, Zurich (CH); Amitkumar SHUKLA, Turgi (CH); Ewelina PRZYBYL, Weurenlingen (CH)

(21) Appl. No.: 15/522,994

(22) PCT Filed: Oct. 27, 2015
(86) PCT No.: PCT/EP2015/074909

§ 371 Date: Apr. 28, 2017

(30) Foreign Application Priority Data
Oct. 28, 2014 (EP) 14190667.7
Nov. 11, 2014 (EP) 14192705.3

(51) Int. Cl. F16L 23/24; F16L 23/20; F16L 23/026; F16L 23/032; F02C 6/18; F02C 7/14

(52) U.S. Cl. CPC F16L 23/24; F16L 23/026; F16L 23/032; F16L 23/20; F02C 7/14; F05D 2220/32; F02C 6/18; F05D 2220/72

(57) ABSTRACT

Dissimilar piping joint arrangement, including a first pipe section and a second pipe section and a dissimilar piping joint between the pipe sections, the first and second consecutive pipe sections being made of first and second metallic materials respectively with different material behavior and properties. An improved lifetime and extended applicability is achieved in that said dissimilar piping joint is a coupling joint, said first pipe section made of said first metallic material is provided at one end with a first coupling made of said first metallic material, said second pipe section made of said second metallic material is provided at one end with a second coupling made of said second metallic material, and the first coupling and the second coupling are bolted together, whereby a first seal is established by direct metallic contact between the front faces of the first coupling and the second coupling.

### BACKGROUND

Embodiments of the invention relate to the technology of piping comprising sections of different materials. It refers to a Dissimilar Piping Joint according to the preamble of claim 1.

The use of different metals/alloys, which differ in their metallurgical behavior and which are called in this context “dissimilar metals” in a joint being exposed to high temperature, high pressure loading, high cyclic, and high transients with external forces and moments, can pose problems of stress and reduced lifetime of this joint.

Present codes and standards/literatures in the industry are less informative about the behavior and safety of such joint and often situation is unsafe.

FIG. 1 shows the basic scheme of a combined cycle power plant (CCPP) 10. The combined cycle power plant 10 of FIG. 1 comprises a gas turbine 11 connected to a water/steam cycle 12 via a heat recovery steam generator (HRSG) 19.

Gas turbine 11 comprises a compressor 14, which aspirates air through an air inlet 13 and delivers the compressed air to a combustor 15, where it is used to generate hot gas by burning fuel 16. The hot gas drives a turbine 17 and the exhaust gas 18 of the turbine 17 passes through the heat recovery steam generator 19 and finally exits as flue gas 20.

Heat recovery steam generator 19 generates steam for a steam turbine 21. In addition, water from the heat recovery steam generator 19 is fed to an air cooler 22 and used to cool down compressed air from the compressor 14, which is fed to the turbine for cooling purposes. While the water is supplied through a water inlet pipe 24, the generated steam flows back to the heat recovery steam generator 19 via steam outlet pipe 23.

A more detailed plan of a combined cycle power plant is shown in document U.S. Pat. No. 6,018,942, for example.

The high pressure air cooler 22 of the gas turbine 11 usually needs to be made of austenitic stainless steel to avoid high temperature corrosion product entering the hot gas path parts of the turbine 17. At the same time, the remaining water/steam side of the plant, which the cooler 22 is connected to, is made of ferritic steel. The weld connection at the steam outlet pipe 23 of the cooler 22 is a dissimilar metal joint or weld of the kind explained above, and thus experiences reduced lifetime issues.

The situation is shown in FIG. 2 in more detail: Steam outlet pipe 23 is connected to air cooler 22 in a special Dissimilar Piping Joint 25, where pipe sections made of three different or dissimilar materials M1, M2 and M3 are connected with each other. Material M1 of the pipe section comprising a level sensing line 27 is for example an stainless steel, M2 is for example nickel alloy and M3 is for example a martensitic ferritic steel. While the joint between pipe sections made of materials M1 and M2 is less critical, the weld seam 26 between the pipe sections made of materials M2 and M3 is a mixed weld seam, which is necessary at the joint between dissimilar metal materials M2 and M3.

One of the main factors leading to premature failure of such a dissimilar metal connection is the very high temperature gradient in the wall of the pipe during start-up of the plant.

### SUMMARY

It is an object of embodiments of the present invention to avoid the problems described in connection with a Dissimilar Piping Joint between dissimilar metal materials.

It is another objective of the embodiments of the present invention to provide a Dissimilar Piping Joint for pipe sections of dissimilar materials, which is free of mixed weld seams to be performed on site.

It is another object of embodiments of the present invention to provide a Dissimilar Piping Joint for pipe sections of dissimilar materials, which achieves extended lifetime considering creep, fatigue and their interaction and results in low maintenance activities.

It is another object of embodiments of the present invention to provide a Dissimilar Piping Joint for pipe sections of dissimilar materials, which requires no major modification to piping design and support concept and is therefore beneficial for existing service fleet.

It is another object of embodiments of the present invention to provide a Dissimilar Piping Joint for pipe sections of dissimilar materials, which has low weight impact and therefore does not require major modifications of an already existing piping as a working system, exposed to dead weight, external loading as forces and moments, thermal restricted expansion, wind and earthquake loads.

These and other objects of embodiments are obtained by a Dissimilar Piping Joint according to Claim 1.

The dissimilar piping joint arrangement according to the embodiments of the invention comprises a first pipe section and a second pipe section and a dissimilar piping joint between the first pipe section and the second pipe section, the first and second pipe sections being made of first and second metallic materials respectively with different material behavior and properties. The pipe sections can be part of piping for example piping which is subjected to boundary conditions of high pressure, high temperature, high cycling, high creep and external forces and moments, especially in a Combined Cycle Power Plant (CCPP).

It is characterized in that said piping joint is a coupling joint, said first pipe section made of said first metallic material is provided at one end with a first coupling made of said first metallic material, said second pipe section made of said second metallic material is provided at one end with a second coupling made of said second metallic material, and the first coupling and the second coupling are bolted together (for example by means of bolts and nuts), whereby a first seal is established by direct metallic contact between the front faces of the first coupling and the second coupling.

According to an embodiment of the invention said first and second couplings are welded to their respective pipe sections.

According to another embodiment of the invention said front faces of said couplings are slightly conical.

Specifically, said front faces of said couplings are conical with an angle of aperture in a range between 178° and 179.9°.

According to another embodiment of the invention said first material is a Ni-based alloy and said second material is a ferritic/martensitic alloy.

According to another embodiment of the invention said first pipe section is welded at the other end from the first coupling to a third pipe section made of a third metallic material different from said first and second metallic material.

According to just another embodiment of the invention said first and second coupling, the front faces of which are slightly conical, each have a central bore, said first seal is established adjacent to said central bore of said couplings, and a second seal is provided, which surrounds said first seal and keeps said Dissimilar Piping Joint tight in case of a failure of said first seal.

Specifically, said second seal comprises a metallic seal ring placed in an annular space being made up by lining grooves in said front faces of said couplings. The lining grooves are adjacent to one another when the first and second couplings are attached to one another.

According to another embodiment of the invention said first and second couplings have outer dimensions substantially smaller than those of standard ASME B16.5 couplings.

According to another embodiment of the invention, a combined cycle power plant with the dissimilar piping joint arrangement described above is provided.

Specifically, said first and second pipe section connect an air cooler of a gas turbine of said combined cycle power plant and a heat recovery steam generator of said combined cycle power plant.

### BRIEF DESCRIPTION OF THE DRAWINGS

Embodiments of the present invention are now to be explained more closely by means of different embodiments and with reference to the attached drawings.

FIG. 1 shows a simplified scheme of a combined cycle power plant CCPP;

FIG. 2 shows an exemplary prior art pipe connection between air cooler and heat recovery steam generator HRSG comprising a critical mixed weld seam;

FIG. 3 shows an embodiment of a coupling Dissimilar Piping Joint according to the embodiments of the invention;

FIG. 4 compares the size of a coupling according to an embodiment of the present invention with the size of a coupling with identical inner diameter according to ASME standard;

FIG. 5 shows details of a coupling with slightly conical front face according to an embodiment of the invention; and

FIG. 6 shows a longitudinal section of a coupling joint with plural seals according to an embodiment of the invention.

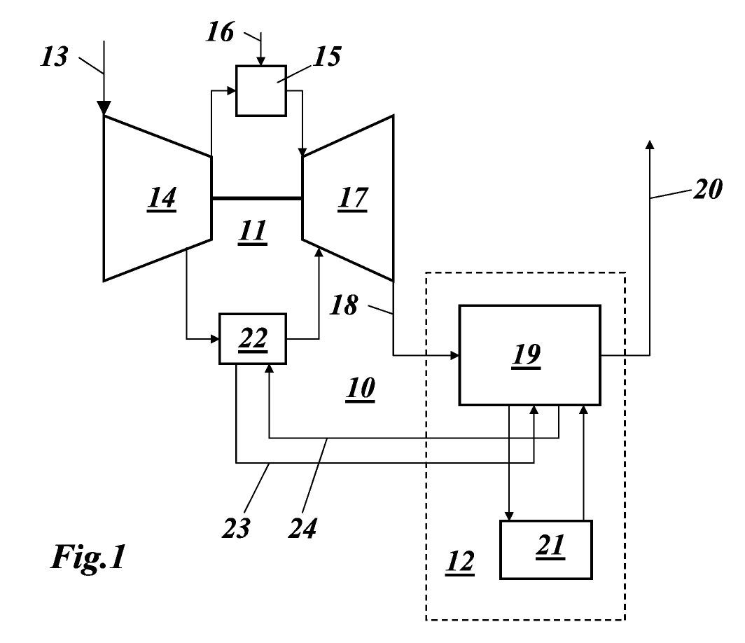

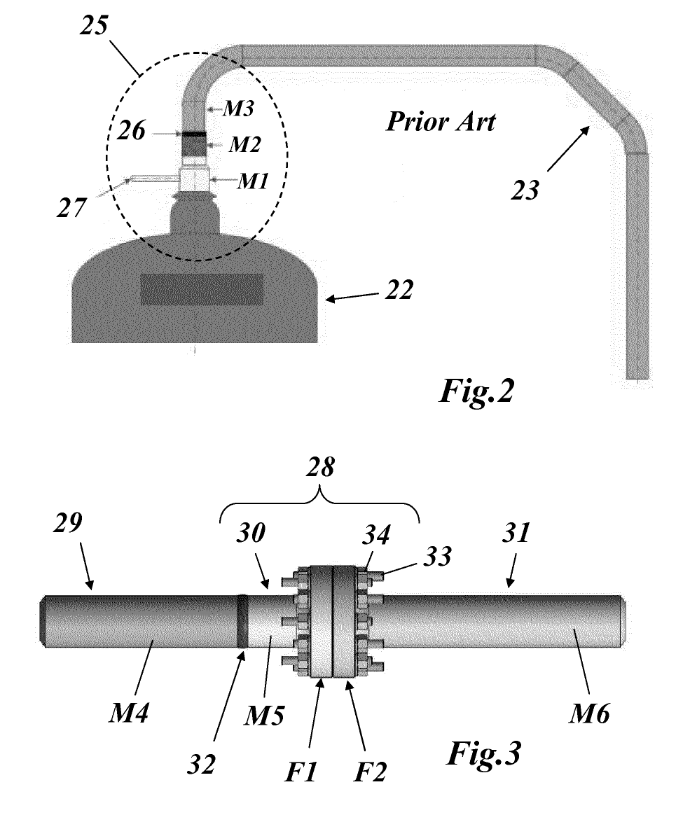

### DETAILED DESCRIPTION

The problems of a connection of stainless steel pipe sections and ferritic steel pipe sections in a piping used in a combined cycle power plant are: An optimization of CTE (coefficient of thermal expansion) mismatch; Fulfillment of operational pressure and temperature ratings; Steep transient conditions during plant start up; Consideration of creep, fatigue and their interaction; Lifetime and allowable number of cycles; Maintenance free till end of lifetime—no interference of operation regime; No mixed weld seams on site; External forces and moments; Easy site replacement of existing arrangement; ASME and PED certification;

According to embodiments of the invention a dissimilar metal coupling joint itself considering different mechanical properties of material involved, is used to provide the critical material transition between the coupling faces that have different material behavior and properties, without the need of fusion of material (mixed weld seam), which can achieve the required lifetime even considering the combination of boundary conditions of high pressure, high temperature, high cycling, high creep and external forces and moments.

FIG. 3 shows an embodiment of a coupling Dissimilar Piping Joint 28 according to embodiments of the invention. A first pipe section 29 made of material (metal) M4 is connected to a second pipe section 30 made of material (metal) M5 by means of a less-critical (material 30 is the integral part of the coupling) weld seam 32. Second pipe section 30 and a third pipe section 31 made of a third material (metal) M6 are connected by means of a coupling joint comprising couplings F1 and F2. Coupling F1 is made of the same material as second pipe section 30, i.e. material M5. Coupling F2 is made of the same material as third pipe section 31, i.e. material M6. Couplings F1 and F2 are connected by means of suitable bolts 33 and nuts 34.

The coupling joint F1, F2 represents a direct material transition from material M5 to material M6.

Due to this arrangement of material M5 and M6 in Dissimilar Piping Joint 28 only homogenous welding work on site is necessary (no mixed weld seam on site). The optimization of different thermal expansion rate is done by the right choice of material M5 and material M6.

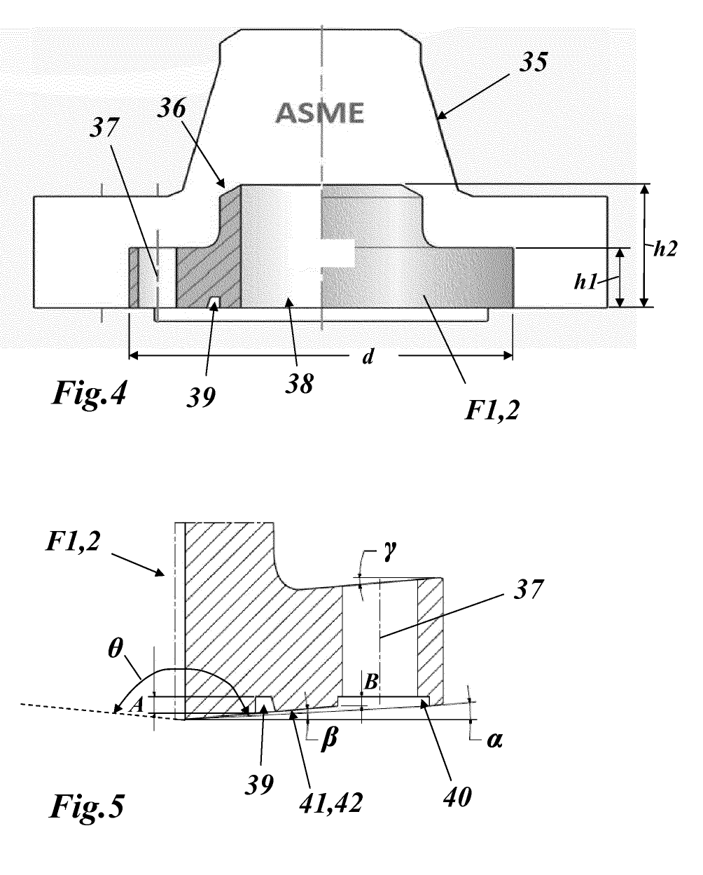

The external dimensions of couplings F1 and F2 can substantially deviate from standard coupling dimensions according to ASME B16.5 standard. FIG. 4 shows a comparison of the outer dimensions of a coupling 35 with welding neck according to ASME B16.5 standard and a (compact) coupling 36 with same inner diameter according to an embodiment of the invention. As can be seen from FIG. 4, the overall height h2 of coupling 36 is less than half of the overall height of ASME standard coupling 35. The coupling height h1 of coupling 36 is about half the coupling height of ASME standard coupling 35. The outer diameter d of coupling 36 is approximately ⅔ of the outer diameter of ASME standard coupling 35.

Thus, compact coupling 36 has only about 60% material volume compared to a traditional (standard) welding neck coupling 35.

This reduction in material volume of the couplings F1 and F2 offers various advantages some of which are: Improved thermal stress behavior during transients; Lower weight; Negligible impact on piping support system 4 no modification on support concept necessary.

Another advantage is related to the specific design of the couplings F1 and F2 with regard to their front faces. According to FIG. 5 the couplings F1 and F2 have slightly conical front faces 42 the conicity or tapering of which is defined by two different angles α and β. Angle β defines the conicity of the main part of front face 42 (inside a circular groove 40) while angle α is related to the conicity of a rim part outside the connecting bores 37 and circular groove 40. Angles α and β are related to the angle of aperture θ of the conical front face 42 by formula

θ=180°−2α or θ=180°—2β, respectively.

With angle α ranging between 0.05° to 0.75° and β ranging between 0.08° to 1.00° the angle of aperture θ can be said to range between 178° and 179.9°. Furthermore, the back side of couplings F1, F2 also has a conicity with an angle γ ranging between 0.04° and 0.8° (angle of aperture between 179.92° and 178.4°).

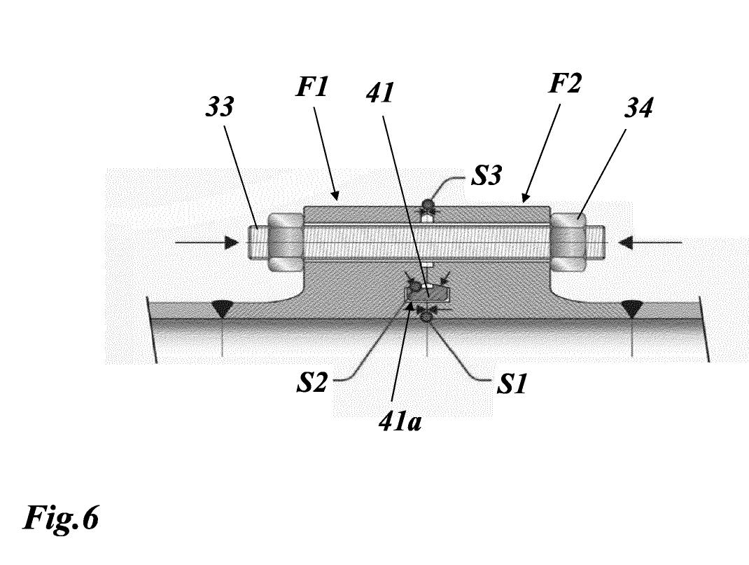

The two-stage two-angle design with angles α and β leads to an optimized lifetime of the joint. The conicity with angle β of the main front face defines a contact pressure at inner bore (heel) 38 of coupling F1, F2 (see seal S1 in FIG. 6)

Elastic deformation of the coupling faces due to optimized bolt pretension force close faces with their conicity angle α at outside diameter (see seal S3 in FIG. 6).

In any case, shear forces due to different expansion of ferritic (material M6) and Ni-base coupling material M5 have to be considered (CTE mismatch optimization).

A coupling Dissimilar Piping Joint according to an embodiment of the invention is shown in the connected state in a longitudinal section in FIG. 6. Couplings F1 and F2 are connected by bolts 33 extending through connecting bores 37 (FIG. 4) and nuts 34.

Compact couplings F1, F2 have no compressed soft gasket, which is directly influencing bolt pretension. Due to metal-to-metal contact at the front faces 42 of couplings F1 and F2 a defined surface pressure is established. Thus, a bolt pretension loss can only be driven by metal behavior and not by any gasket compression loss.

As shown in FIG. 6 the compact coupling design comprises two main seal areas with a first metallic face-to-face seal S1 adjacent to central bore 38 (heel) of couplings F1, F2. A second seal S2 surround the first seal S1. Second seal S2 comprises a hollow annular space 41a made up by opposing lining grooves 39 in the front face of each coupling F1, F2. A metal seal ring 41 is inserted into said annular space 41a and compressed in radial direction when the couplings F1, F2 are connected.

The outer second seal S2 is only in operation when inner first seal S1 (heel area) has opened resulting in a double sealing instead of one main seal only. Metal seal ring of second seal S2 is self-energized. The gasket is compressed by bolt force only. Third seal S3 acts as an environmental seal.

The characteristic features of the pipe transition according to embodiments of the invention and its various embodiments can be summarized as follows: A dissimilar metal coupling joint (F1, F2) itself considering different mechanical properties of material involved, is used to provide the critical material transition between the coupling faces 41 that have different material behavior and properties, without the need of fusion of material (mixed weld seam), which can achieve the required lifetime even considering the combination of boundary conditions of high pressure, high temperature, high cycling, high creep and external forces and moments. CTE (Coefficient of thermal expansion) mismatch of the involved materials is optimized via material selection which covers the given boundary conditions on one side and offers the smallest possible difference in CTE. One embodiment involves the design of coupling face angles α and β and pre-stressing, which are optimized to control creep and fatigue behavior of the whole coupling system to achieve the target values of lifetime and load cycles. Number and diameter of bolts 33 are optimized considering creep, fatigue and stresses due to external forces and moments. The bolts loading has very high pretension (ranging up to 120-160 kN) to keep coupling joint 28 together considering high loss of pretension expected during service. The bolt loading is applied with special hydraulic tools to achieve tension only and no additional stress due to torsion. Double sealing with primary and secondary seals S1 and S2 is used as a typical feature of the coupling design: For the primary seal S1, the mechanical integrity calculations are used to control local stress, creep and fatigue behavior via proper pre-stressing the whole system in order to achieve given load cycles and lifetime. In such a way, the primary seal S1 is still in sufficient contact after intended lifetime. The function of the secondary seal S2 is not required even at the end of intended lifetime. Secondary seal S2 will hardly see any contact with fluid and pressure, but is considered as an additional safety measure against leakage. Even in case primary seal S1 would lose sufficient contact pressure, the secondary seal S2 could overtake the full tightness function. This results in leak free design and is 100% EHS compliant.

The benefits of the solution according to embodiments of the invention are: Prevention of mixed weld seams to be performed on site. Achievement of extended lifetime considering creep, fatigue and their interaction. The components involved are designed for increased operational intervals (as high as up to 50,000 EOH). They do not require maintenance in between, which would disturb operation. Therefore, maintenance activities are lower. Double sealing against leakage makes sure that even in case of primary seal losing sufficient contact pressure; secondary seal could overtake the full tightness function. No major modification expected to piping design and support concept which is beneficial for existing service fleet. The new coupling concept has low weight impact which means the coupling installation does not require major modifications of the present piping as a working system, exposed to dead weight, external loading as forces and moments, thermal restricted expansion, wind and earthquake loads.

1. A dissimilar piping joint arrangement comprising
a first pipe section comprising a first metallic material;
a second pipe section comprising a second metallic material;
a dissimilar piping joint defining a coupling joint, wherein said first pipe section is provided at one end with a first coupling made of said first metallic material, said second pipe section is provided at one end with a second coupling made of said second metallic material, and the first coupling and the second coupling are bolted together; and
a first seal that is established by direct metallic contact between the front faces of the first coupling and the second coupling.

2. A dissimilar piping joint arrangement according to claim 1, wherein said first and second couplings are welded to their respective pipe sections.

3. A dissimilar piping joint arrangement according to claim 1, wherein said front faces of said couplings are slightly conical.

4. A dissimilar piping joint arrangement according to claim 1, wherein said front faces of said couplings are conical with an angle of aperture in a range between 178° and 179.9°.

5. A dissimilar piping joint arrangement according to claim 1, wherein said first material is a Ni-based alloy and said second material is a ferritic/martensitic alloy.

6. A dissimilar piping joint arrangement according to claim 5, wherein said first material is an Alloy 625 Grade 2 and said second material is an alloy.

7. A dissimilar piping joint arrangement according to claim 1, wherein said first pipe section is welded at the other end from the first coupling to a third pipe section made of a third metallic material different from said first and second metallic materials.

8. A dissimilar piping joint arrangement according to claim 7, wherein said third metallic material is steel.

9. A dissimilar piping arrangement according to claim 3, wherein said first and second couplings each have a central bore, said first seal is established adjacent to said central bore of said couplings, and a second seal is provided, which surrounds said first seal and keeps said dissimilar piping joint tight in case of a failure of said first seal.

10. A dissimilar piping joint arrangement according to claim 9, wherein said second seal comprises a metallic seal ring placed in an annular space being made up by lining grooves in said front faces of said couplings.

11. A dissimilar piping joint arrangement as claimed in claim 1, wherein said first and second couplings have outer dimensions substantially smaller than those of standard ASME B16.5 couplings.

12. A combined cycle power plant comprising:
a dissimilar piping joint arrangement comprising
a first pipe section comprising a first metallic material;
a second pipe section comprising a second metallic material;
a dissimilar piping joint defining a coupling joint, wherein said first pipe section is provided at one end with a first coupling made of said first metallic material, said second pipe section is provided at one end with a second coupling made of said second metallic material, and the first coupling and the second coupling are bolted together; and
a first seal that is established by direct metallic contact between the front faces of the first coupling and the second coupling.

13. A combined cycle power plant according to claim 12, wherein said first and second pipe sections connect an air cooler of a gas turbine of said combined cycle power plant and a heat recovery steam generator of said combined cycle power plant.
